(19) United States
(12) Patent Application Publication
(10) Pub. No.: US 2013/0078907 A1
(43) Pub. Date: Mar. 28, 2013

(54) PER CARRIER GAIN CONTROL IN A MULTI-CARRIER REPEATER

(71) Applicants: Dhananjay Ashok Gore, Bangalore (IN); Michael Mao Wang, San Diego, CA (US); Gwendolyn Denise Barriac, Encinitas, CA (US); James Arthur Proctor, JR., Melbourne Beach, FL (US)

(72) Inventors: Dhananjay Ashok Gore, Bangalore (IN); Michael Mao Wang, San Diego, CA (US); Gwendolyn Denise Barriac, Encinitas, CA (US); James Arthur Proctor, JR., Melbourne Beach, FL (US)

(73) Assignee: QUALCOMM Incorporated, San Diego, CA (US)

(21) Appl. No.: 13/243,949

(22) Filed: Sep. 23, 2011

(51) Int. Cl. H04B 15/00; H04B 7/15

(52) U.S. Cl. 455/11.1; 455/7

(57) ABSTRACT

A method for adjusting per-carrier gains in a repeater is presented. The method may include determining a separate gain value for each carrier frequency in a signal. The method may further include applying the separate gain value to each carrier frequency in the signal to form a per-carrier gain adjusted signal. The method may also include adjusting the separate gain values based upon a per-carrier stability metric.

### REFERENCE TO CO-PENDING APPLICATIONS FOR PATENT

The present Application for Patent is related to the following co-pending U.S. Patent Application: “STABILITY INDICATOR FOR A WIRELESS REPEATER” having U.S. application Ser. No. 12/722,730, filed on Mar. 12, 2010, having Attorney Docket No. 082758, assigned to the assignee hereof, and expressly incorporated by reference herein.

### BACKGROUND

1. Field

This disclosure generally relates to repeaters in wireless communication systems, and in particular, to per carrier gain control techniques in a multi-carrier echo cancellation wireless repeater.

2. Background

In general, a repeater is a device that receives a signal, amplifies the signal, and transmits the amplified signal. FIG. 1 shows a basic diagram of a repeater 110, in the context of a wireless communications system. Repeater 110 may include a donor antenna 115 as an example network interface to network infrastructure such as a base station 125. Repeater 110 also includes a server antenna 120 (also referred to as a “coverage antenna”) as a mobile interface to mobile device 130. In operation, donor antenna 115 may be in communication with base station 125, while server antenna 120 may be in communication with mobile devices 130. In repeater 110, signals from base station 125 may be amplified using forward link circuitry 135, while signals from mobile device 130 may be amplified using reverse link circuitry 140. Many configurations may be used for forward link circuitry 135 and reverse link circuitry 140.

Repeaters may take on a wide variety of different forms depending upon their intended environment of operation, functional requirements, and/or performance requirements. For some repeaters, both the network and mobile interfaces are wireless. In other repeaters, a wired network interface may be used. Some repeaters receive signals with a first carrier frequency and transmit amplified signals with a second different carrier frequency, while others receive and transmit signals using the same carrier frequency. For “same frequency” repeaters, one particular challenge is managing the feedback that occurs when some of the transmitted signal leaks back to the receive circuitry and is amplified and transmitted again.

Existing repeaters manage feedback using a number of techniques. For example, the repeater may be configured to provide physical isolation between the two antennae, filters may be used, and/or other conventional techniques may be employed.

Conventional repeaters such as those described above may provide significant advantages for cellular telephone or similar networks. However, existing repeater configurations may not be suitable for some applications. For example, existing repeater configurations may not be suitable for indoor coverage applications (e.g., repeating signals for a residence or business environment) which may require substantially more isolation between the repeater's antennas. Moreover, in some traditional repeater implementations, the target is to achieve as high a gain as reasonable while maintaining a stable feedback loop (loop gain less than unity). However, increasing the repeater gain renders isolation more difficult due to the increased signal leaking back into the donor antenna. In general, loop stability requirements imply that the signal leaking back into the donor antenna from the coverage antenna be much lower than the remote signal (the signal to be repeated). The maximum achievable signal to interference/noise ratio (SINR) at the output of the repeater is then the same as the SINR at the input to the repeater. High gain and improved isolation impose two contradicting demands required for modern day repeaters, especially those for indoor applications.

In order for a repeater to remain stable, the loop gain of the system should remain less than 1. Hence, to ensure stability, a repeater should be able to accurately measure the loop gain, and to react quickly by lowering overall gain, should the loop gain start to increase. However, this process is not so straightforward if the repeater is amplifying multiple carriers. The average loop gain on each carrier can be very different, and if only one average loop gain metric is used across all carriers, the system may go unstable. One technical challenge is how to amplify (i.e. repeat) multiple carriers while ensuring system stability across the entire band. One possible way for a repeater to amplify multiple carriers is to simply utilize the single carrier solution for each of the carriers. However, for repeaters employing interference cancellation, this solution may have worse cancellation than having wideband approach because the leakage from adjacent carriers isn't cancelled out. However, using a wideband approach for gain control can create problems. For example, if one of the carriers has lower input power than the others, instabilities on this carrier are “averaged” out and hence the system may respond to real instabilities and thus could go unstable.

### SUMMARY

In one embodiment, a method for adjusting per-carrier gains in a repeater is presented. The method may include determining a separate gain value for each carrier frequency in a signal. The method may further include applying the separate gain value to each carrier frequency in the signal to form a per-carrier gain adjusted signal. The method may also include adjusting the separate gain values based upon a per-carrier stability metric.

In another embodiment, a wireless repeater is presented. The wireless repeater may include a first antenna to receive an input signal and a second antenna to transmit an amplified signal. The input signal is a sum of a remote signal to be repeated and a feedback signal resulting from a feedback channel between the first antenna and the second antenna. The wireless repeater further includes a first front-end block coupled to the first antenna which receives the input signal, the first front end block further comprising receive and transmit front-end processing circuitry. The wireless repeater further includes a second front-end block coupled to the second antenna which generates the amplified signal, the second front-end block further comprising receive and transmit front-end processing circuitry. The wireless repeater further includes a repeater baseband block coupled between the first and second front-end blocks. The repeater baseband block may be configured to receive a processed input signal from the first front-end block, and generate a per carrier gain adjusted signal to be processed by the second front-end block. The repeater baseband block may further include a channel estimation block which receives the processed input signal and estimates the feedback channel to provide a feedback channel estimate, an echo canceller which receives the feedback channel estimate and generates a feedback signal estimate to substantially cancel the feedback signal from the input signal, a multi-carrier variable gain stage to amplify the echo cancelled signal on a per carrier basis to generate a per-carrier adjusted signal; a multi-carrier gain control block to adjust the gains of each carrier in the multi-carrier variable gain stage; a first variable delay element to introduce a first delay either before or after echo cancellation; and a second variable delay element to introduce a second delay to the per-carrier adjusted signal, wherein the delayed per-carrier adjusted signal is provided to the channel estimation block as a reference signal to estimate the feedback channel.

### BRIEF DESCRIPTION OF THE DRAWINGS

FIG. 1 is a simplified diagram of a conventional repeater.

FIG. 2 shows a diagram of an exemplary environment for an echo cancellation repeater utilizing per carrier gain control.

FIG. 3 is a block diagram of a multi-carrier echo cancellation repeater implementing per carrier gain control according to one embodiment of the disclosure.

FIG. 4 is a block diagram of an echo cancellation repeater implementing per carrier gain control using a discrete set of filters.

FIG. 5 is a conceptual block diagram showing the details of a multi-carrier variable gain stage according to an embodiment of the disclosure.

FIG. 6 is a block diagram of an echo cancellation repeater implementing per carrier gain control using a combined set of filters.

FIG. 7 is a block diagram showing further implementation details of a multi-carrier variable gain stage according to an embodiment of the disclosure.

FIG. 8 is an exemplary process for performing per-carrier gain control in a multi-carrier repeater.

FIG. 9 is a structural block diagram of an echo cancellation repeater which can be configured to implement per carrier gain control.

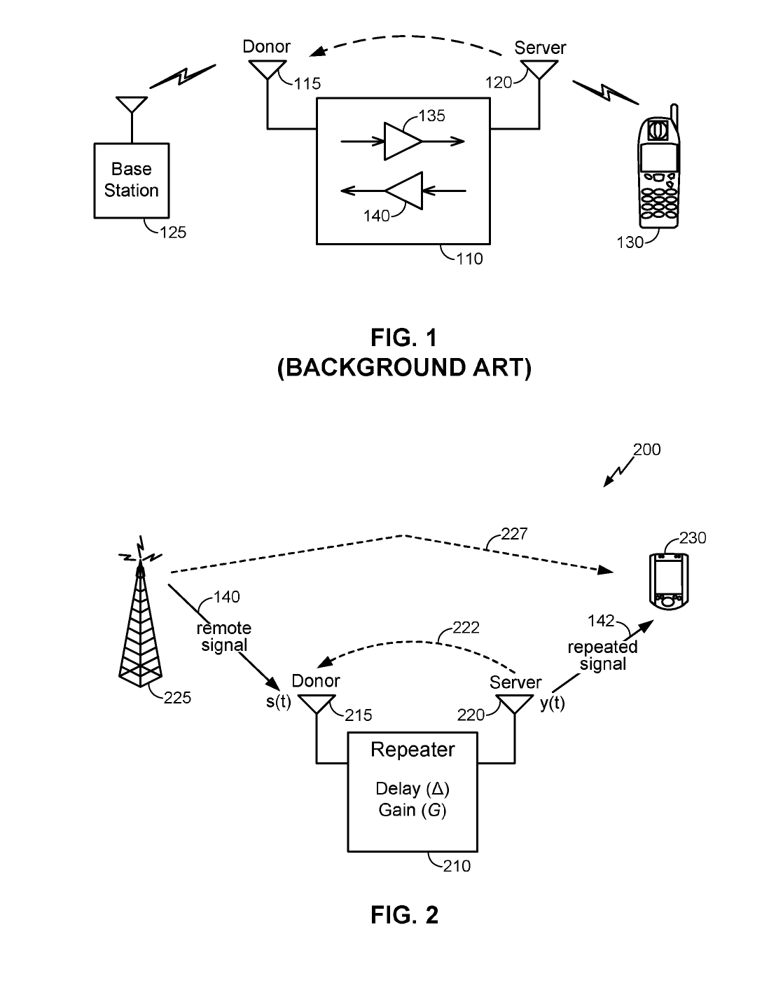

### DETAILED DESCRIPTION

The nature, objectives, and advantages of the disclosed method and apparatus will become more apparent to those skilled in the art after considering the following detailed description in connection with the accompanying drawings.

Systems and techniques herein provide for wireless repeaters with improved isolation between the repeaters' donor antenna (“the receiving antenna” for the example of a forward link transmission) and the coverage antenna (“the transmitting antenna” for forward link transmissions). Furthermore, in some embodiments, systems and techniques herein provide for a unique repeater design employing interference cancellation or echo cancellation to significantly improve the isolation. In some embodiments, the interference cancellation and echo cancellation are realized using improved channel estimation techniques provided herein for accurate estimation of the channel. Effective echo cancellation utilizes accurate channel estimation of the leakage channel. In general, the more accurate the channel estimate, the higher the cancellation and hence the higher the effective isolation. Herein, “interference cancellation” or “echo cancellation” refers to techniques that reduce or eliminate the amount of leakage signal between repeater antennas; that is, “interference cancellation” refers to cancellation of an estimated leakage signal, which provides for partial or complete cancellation of the actual leakage signal.

According to another aspect, systems and techniques herein provide for a unique wireless repeater design employing gain control techniques for enhancing the stability of the repeater system. In some embodiments, a metric for measuring the stability of the repeater system is provided. The gain of the repeater is controlled based on the value of the metric as an indicator of stability. For example, in the event of large signal dynamics, a metric, such as the loop gain, becomes degraded and the gain will be reduced to keep the repeater system stable. The gain control methods and systems can be advantageously applied to repeaters employing interference cancellation or repeaters not employing interference cancellation.

FIG. 2 shows a diagram of an environment 200 for a repeater 210 according to embodiments of the current disclosure. The example of FIG. 2 illustrates forward link transmissions, such as a remote signal 140 from a base station 225, which is intended for a mobile device 230. The remote signal may include multiple carrier frequencies consistent with modern modulation techniques. A repeater 210, may be used in environment 200 if an un-repeated signal along the path 227 between base station 225 and mobile device 230 would not provide sufficient signal for effective voice and/or data communications received at mobile device 230. Repeater 210 with an overall gain G and a delay Δ is configured to repeat a signal received from base station 225 on a donor antenna 215 to mobile device 230 using a server antenna 220. Repeater 210 includes forward link circuitry for amplifying and transmitting signals received from the base station 225 to mobile device 230 through donor antenna 215 and server antenna 220. Repeater 210 may also include reverse link circuitry for amplifying and transmitting signals from mobile device 230 back to base station 225. At repeater 210, the remote signal s(t) is received as an input signal and the remote signal s(t) is repeated as a repeated or amplified signal y(t) where y(t)=\sqrt{G}s(t−Δ). Ideally, the overall gain G would be large, the inherent delay Δ of the repeater would be small, the input SINR would be maintained at the output of repeater 210 (this can be of particular importance for data traffic support), and only desired carriers would be amplified.

In practice, the overall gain of repeater 210 may be limited by the isolation between donor antenna 215 and server antenna 220. If the overall gain is too large, the repeater can become unstable due to signal leakage. Signal leakage refers to the phenomenon where a portion of the signal that is transmitted from one antenna (in FIG. 2, server antenna 220) is received by the other antenna (in FIG. 2, donor antenna 215), as shown by the feedback path 222 in FIG. 2. Without interference cancellation or other techniques, the repeater would amplify this feedback signal, also referred to as the leakage signal, as part of its normal operation, and the amplified feedback signal would again be transmitted by server antenna 220. The repeated transmission of the amplified feedback signal due to signal leakage and high repeater gain can lead to repeater instability. Additionally, signal processing in repeater 210 has an inherent non-negligible delay A. The output SINR of the repeater is dependent on RF non-linearities and other signal processing. Thus, the aforementioned ideal repeater operational characteristics are often not attained.

In embodiments of the current disclosure, a repeater suitable for indoor coverage (e.g., business, residential, or similar use) is provided. The repeater has an active overall gain of about 70 dB or greater which is an example of a sufficient gain for coverage in a moderately sized residence. Furthermore, the repeater has a loop gain of less than one for stability (loop gain being referred to as the gain of the feedback loop between the transmitting antenna and the receiving antenna) and a sufficient amount of margin for stability and low output noise floor. The stability of the loop gain can be maintained by controlling separate gains associated with individual carriers in the remote signal, as will be discussed in more detail below. In some embodiments, the repeater has a total isolation of greater than 80 dB. In some embodiments, the repeater employs interference/echo cancellation to achieve a high level of active isolation, which may be more challenging than the requirements of available repeaters.

Better stability may be achieved through embodiments which include a separate loop gain metric computed for each carrier frequency being repeated. Towards this end, separate stability control algorithms may be implemented for each carrier in a multi-carrier signal. As used herein, this type of gain control is referred to as “per carrier” gain control. One way to achieve per carrier gain control is to include a loop gain computation block for each carrier, with the input to each loop gain computation block being filtered so that the frequency components are only in the frequency range of the desired carrier.

If the loop gain metric is computed separately for different frequencies, but only the worst measurement is used for gain control, then the performance the whole system is limited by the performance of the worst carrier. By having a separate stability indicator and gain control per carrier, the system can not only ensure stability, but it can also ensure the performance of each carrier is not limited by the performance of the worst carrier.

In addition, some techniques of the current disclosure utilize channel estimation to enable the required level of echo cancellation. By estimating the feedback channel (the channel between the antennas) to a sufficient degree of accuracy, the residual error, post echo cancellation, can be sufficiently below the remote signal to realize the desired loop gain margin for stability.

The communication system in which the repeater can be deployed includes various wireless communication networks based on infrared, radio, and/or microwave technology. Such networks can include, for example, a wireless wide area network (WWAN), a wireless local area network (WLAN), a wireless personal area network (WPAN), and so on. A WWAN may be a Code Division Multiple Access (CDMA) network, a Time Division Multiple Access (TDMA) network, a Frequency Division Multiple Access (FDMA) network, A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The systems and techniques described herein may also be used for any combination of WWAN, WLAN and/or WPAN.

### Feedback/Delay Interference Cancellation Repeaters

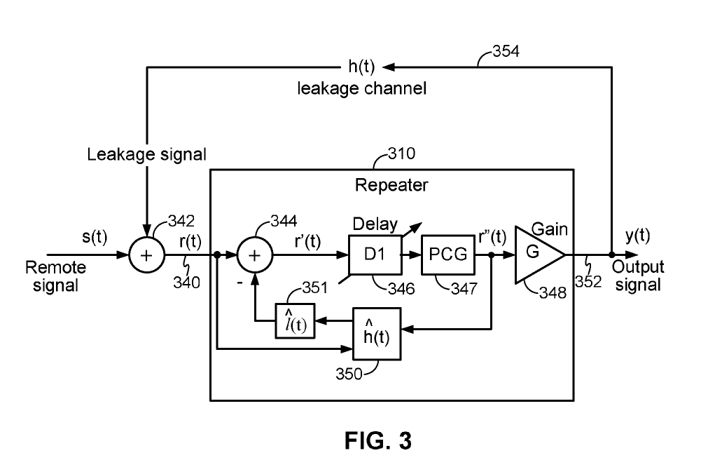

In some embodiments, a repeater employing echo cancellation uses the transmit signal as the pilot or reference signal for estimating the feedback channel (or “the leakage channel”) and also for echo cancellation. For the purpose of estimating the feedback channel, the transmit signal may be the pilot and the remote signal may be treated as noise. The received signal of the repeater is the remote signal plus the feedback signal (or the leakage signal). The transmit signal may be fed into the channel estimation algorithm and the resulting feedback channel estimate can be used to generate a replica of the feedback signal—that is, the portion of the transmit signal that was echoed back to the donor antenna. The estimated feedback signal may then be subtracted from the received signal to cancel out the undesired feedback signal at the input to the repeater. Echo cancellation may thus be realized in the repeater. In one embodiment, a feedback delay control method is implemented in an echo cancellation repeater to improve the channel estimation and echo cancellation performance. In the feedback delay control method, a variable delay (D1) is introduced in the repeater to decrease the correlation between the pilot and the remote signal. Correlation between the pilot, which is the transmit signal, and the remote signal can degrade the channel estimation. The values of variable delay D1 may be selected to introduce enough delay to reduce the correlation without degrading the performance of the repeater. Details of the feedback delay control method in an echo cancellation repeater will be described in more detail below with reference to FIG. 3.

For typical repeater operation, the total loop gain should be less than 1 for stability. This usually implies that in typical repeaters, the overall gain ‘G’ is limited by the antenna isolation (from transmit to receive). According to one aspect, the effective isolation is increased through baseband interference cancellation where the feedback signal is estimated and cancelled at baseband in the repeater device. Moreover, the per carrier gain control which is performed within the baseband interference cancelation loop can improve gain stability and reduce the convergence time of the interference cancellation process.

FIG. 3 is a block diagram of an exemplary echo cancellation repeater implementing per carrier gain control. Referring to FIG. 3, the ‘remote signal’ s(t) is the signal to be amplified, the ‘output signal’ y(t) is the amplified signal and the ‘leakage signal’ or ‘feedback signal’ is an attenuated version of the output signal that leaks back into the receive (or donor) antenna from the transmit (or coverage) antenna. The feedback channel, also referred to as the leakage channel, is depicted as ‘h(t)’.

With reference to FIG. 3, echo cancellation repeater 310 receives a remote signal s(t) on a donor antenna (denoted as input node 340) and generates an output signal y(t) to be transmitted on a server antenna (denoted as output node 352). Signal leakage from the server antenna back to the donor antenna causes part of the output signal y(t) to be leaked back and added to the remote signal before being received by the repeater. The signal leakage is represented as the transmitted samples convolved with the feedback channel h(t), denoted as a signal path 354 between output node 352 and the input node 340. Thus, repeater 310 actually receives as the input signal a receive signal r(t) being the sum of the remote signal s(t) and the feedback signal. Summer 342 in FIG. 3 is symbolic only to illustrate the signal components of receive signals r(t) and does not represent an actual signal summer in the operating environment of repeater 310.

Echo cancellation repeater 310 operates to estimate the feedback signal in order to cancel out the undesired feedback signal component in the received signal. To that end, receive circuitry of repeater 310 includes an echo canceller formed by a summer 344 and a feedback signal estimation block 351 working in conjunction with a channel estimation block 350. The received signal r(t) is coupled to summer 344 which operates to subtract a feedback signal estimate \hat{l}(t) from the receive signal r(t). As long as the) feedback signal estimate \hat{l}(t) is accurate, the undesired feedback signal may be removed from the receive signal and echo cancellation can be realized. In the present embodiment, the post cancellation signal r′(t) may be coupled through a delay element 346 having a variable delay D1 and then coupled to a per carrier gain (PCG) stage 347 to provide separate gain control over a plurality of carriers in the post cancellation signal. After per carrier gain adjustment, the signal may be passed to a gain stage 348 that generates the output signal y(t) on the output node 352 for transmission on the server antenna. FIG. 3 illustrates only elements that are relevant to operation of the feedback delay control method in an echo cancellation repeater. Repeater 310 may include other elements not shown in FIG. 3 but known in the art to realize the complete repeater operation.

The channel estimation block 350 operates to estimate the feedback channel h(t) and computes an estimate of the feedback channel ĥ(t). Feedback signal estimation block 351 takes the feedback channel estimate ĥ(t) and computes an estimate of the feedback signal for the purpose of echo cancellation. In the present embodiment, the channel estimation block 350 uses the receive signal r(t) and also uses the echo cancelled signal as the pilot signal or the reference signal for channel estimation. The feedback signal estimation block 351 computes the feedback signal estimate \hat{l}(t) based on the feedback channel estimate ĥ(t) where the feedback signal estimate is used for echo cancellation at summer 344. More specifically, the feedback signal estimate \hat{l}(t) is a convolution of the feedback channel estimate ĥ(t) and the reference signal which is indicative of the transmit signal.

According to one feedback delay control method, a variable delay D1 may be provided in the receive circuitry of echo cancellation repeater 310 to introduce a delay in the post cancellation signal of the echo cancellation repeater. The delay D1 may be just large enough for the output signal y(t) and the remote signal s(t) to be decorrelated but small enough to meet repeater performance requirement. For example, the delay may be selected to provide decorrelation between the output signal y(t) and the remote signal s(t), but less than a maximum desired decorrelation delay amount. The variable delay D1 may be tunable and can be adjusted when the repeater is started up and can be tuned periodically when the repeater is in operation to account for changes in the correlation structure of the remote signal. In the present embodiment, repeater 310 may include a delay element 346 in the signal path of the post cancellation signal to introduce a delay D1 to the post cancellation signal r′(t). The delayed echo cancelled signal r″(t) may be coupled to gain stage 348 to generate the output signal y(t). The delayed echo cancelled signal r″(t) may also be coupled to the channel estimation block 350 for use in channel estimation and may be further coupled to the feedback signal estimation block 351 for estimating the feedback signal (not shown). In this manner, a certain amount of delay D1 can be introduced between the output signal y(t), which may be being fed back through the feedback channel h(t) as the feedback signal, and the remote signal s(t). In an embodiment, the amount of delay D1 may be tuned or adjusted by searching. That is, the delay D1 can be adjusted until either the maximum allowable delay is reached or until the echo cancelled output signals y(t) are sufficiently decorrelated from the remote signal s(t). In another embodiment, the correlation or decorrelation of the remote signal s(t) and output signal y(t) is measured directly or inferred through other measurements (such as the overall cancellation gain). The appropriate delay is then computed from the computed correlation.

In the above described embodiments of the feedback delay control method, the variable delay D1 is introduced to the post cancellation signal of the echo cancellation repeater. In other embodiments, the feedback delay control method introduces a variable delay D1 in an echo cancellation repeater at any point in the feed-forward portion of the repeater. In particular, in one embodiment, the variable delay D1 is introduced in the repeater circuit before the echo cancellation. Regardless of where delay D1 is introduced in the signal path of the echo cancellation repeater, the feedback delay control method operates in the same manner to decorrelate the output signal y(t) from the remote signal s(t) to improve the channel estimation accuracy and thereby improve the repeater performance.

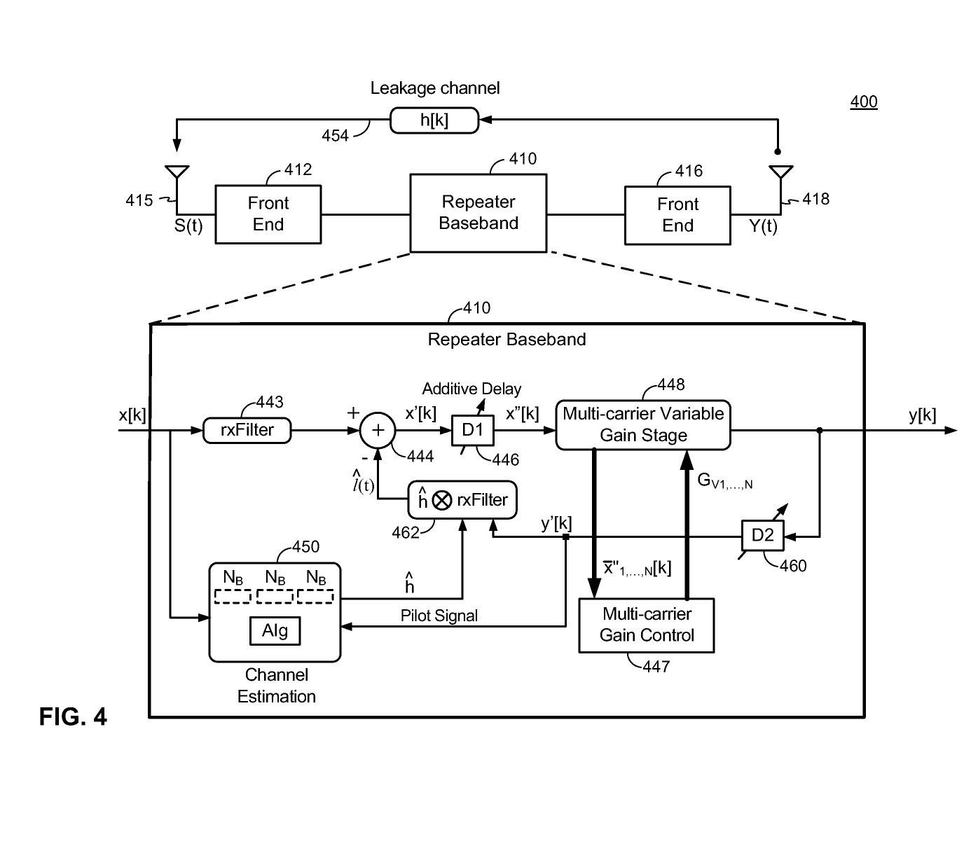

FIG. 4 is a block diagram of an echo cancellation repeater 400 implementing per carrier gain control using a discrete set of filters. As shown in the upper portion of FIG. 4, an echo cancellation repeater 400 receives a remote signal S(t) on a first antenna 415 to be repeated and generates an output signal Y(t) to be transmitted on a second antenna 418. Echo cancellation repeater 400 may include a first front-end circuit 412 coupled to the first antenna 415, a second front-end circuit 416 coupled to the second antenna 418, and a repeater baseband block 410 coupled between the first and second front-end circuits. Note that echo cancellation repeater 400 may be configured so the circuitry (e.g., first front-end circuit 412, second front-end circuit 416) can be coupled to the appropriate antenna for the particular communication (forward and/or reverse link). The first and second front-end circuits 412, 416 incorporate digital and/or analog front-end processing circuitry for implementing the receive and transmit functions of the wireless repeater. The first and second front-end circuits 412, 416 include circuitry of echo cancellation repeater 400 that may be outside of the repeater baseband block 410. In one embodiment, the first and second front-end circuits 412, 416 each include digital and/or analog front-end processing circuitry used in conventional wireless receivers and transmitters. The receiver/transmitter front-end processing circuitry can include variable gain amplifiers, filters, mixers, drivers and/or digital signal processors. The specific implementation of the repeater front-end circuits 412, 416 is not critical to the practice of the present invention and any receiver/transmitter front-end processing circuitry, presently known or to be developed, can be applied in the wireless repeater of the present invention. Echo cancellation repeater 400 includes repeater baseband block 410 where channel estimation, baseband echo cancellation, and per carrier gain control operations are implemented. Details of the repeater baseband block 410 are illustrated in the lower section of FIG. 4.

The repeater baseband block 410 receives an input signal x[k] and generates an output signal y[k]. The input signal x[k] is the sum of a sampled version of the remote signal S[k] to be repeated and a feedback signal resulting from a feedback channel between the first antenna 415 and the second antenna 418. In operation, signal leakage from the server antenna back to the donor antenna causes part of the output signal Y(t) to be leaked back through a feedback channel and added to the remote signal S(t) before the signal is received by the repeater. Thus, echo cancellation repeater 400 actually receives an input signal being the sum of the remote signal S(t) and the feedback signal, where the feedback signal is basically an attenuated version of the output signal Y(t). Echo cancellation repeater 400, being an echo cancellation repeater, operates to estimate the feedback signal in order to cancel out the undesired feedback signal component in the receive signal. In FIG. 4, an echo cancellation repeater 400 receives a remote signal S(t) on the first antenna 415 to be repeated and generates an output signal Y(t) to be transmitted on the second antenna 418. Signal leakage from the second antenna 418 back to the first antenna 415 causes part of the output signal Y(t) to be leaked back and added to the remote signal before being received by the repeater. The signal leakage goes through a feedback channel h[k], denoted as a signal path 454.

Referring to the lower section of FIG. 4, in the repeater baseband block 410, the sampled receive signal x[k] (“the input signal”) is coupled to a receive filter 443 (“rxFilter”) and the filtered receive signal is coupled to a summer 444 which operates to subtract a feedback signal estimate \hat{l}(t) from the filtered receive signal. As long as the feedback signal estimate is reasonably accurate, the undesired feedback signal may be removed from the receive signal and echo cancellation can be realized. The post cancellation signal x′[k] may be coupled through a delay element 446 having a variable delay D1, to produce x″[k]. Variable delay D1 may be introduced in accordance with a feedback delay control method to reduce the correlation between the output signal and the remote signal, thereby improving the feedback channel estimate and repeater performance. Variable delay D1 is optional in the present embodiment and may be omitted in other embodiments.

The delayed post cancellation signal x″[k] may be coupled to a multi-carrier variable gain stage 448 providing a variable gain of G_{vC}, where C is an index representing different carriers located at different frequencies. Multi-carrier variable gain stage 448 may provide both filtering and variable gain on a per channel basis. The gain for each carrier may be controlled by a multi-carrier gain control block 447. The output of multi-carrier variable gain stage 448 is an output signal y[k], which is coupled to the second front end block 416 where a final gain stage (not pictured) provides an RF gain of G_{f}. The final gain stage generates the amplified output signal Y(t) (“the amplified signal”) on the output of the second front end block 416.

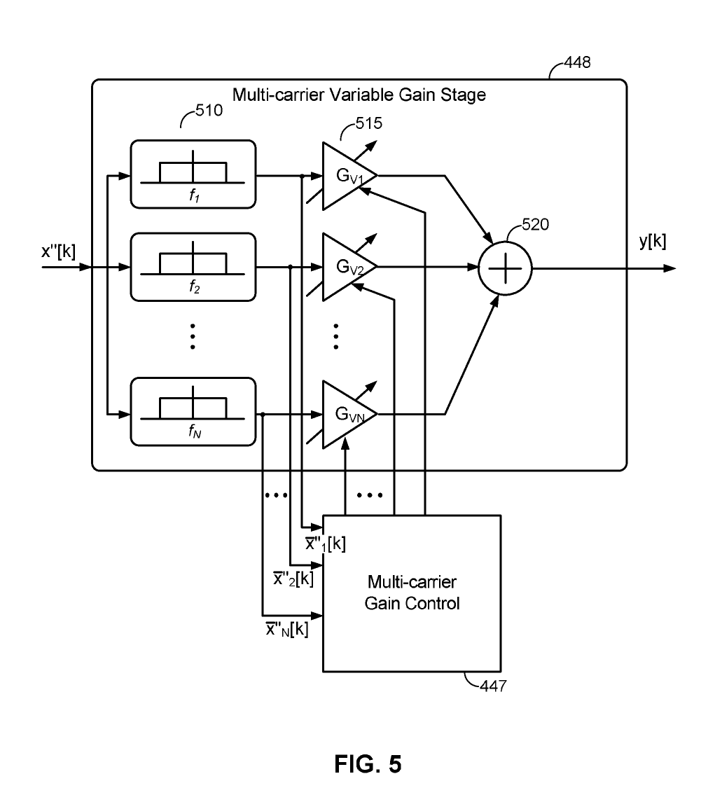

As will be discussed in more detail below in the description of FIG. 5, the multi-carrier variable gain stage 448 may separate the delayed post cancellation signal x″[k] into N signal components ē″₁[k], . . . , x̅″_{N}[k]. Each signal component x̅″ᵢ[k] represents a sub-band of frequencies contained in the signal x″[k] which are centered at a frequency fᵢ. Frequencies f₁, . . . , f_{N} correspond to the center frequencies of the N carriers. The N signal components x̅″₁[k], . . . , x̅″_{N}[k] may be provided to the multi-carrier gain control block 447 as input for determining variable gain control values Gᵥ₁, . . . , G_{vN}. Once determined, the gain control values may be provided back to the multi-carrier variable gain stage 448, where each gain control value Gᵥᵢ can be applied to the appropriate component x̅″ᵢ[k] to provide per-carrier gain adjustment. In some embodiments, the multi-carrier gain control block 447 may adjust the gains for each carrier using separate control loops, which run independently for each carrier, based on per-carrier stability metrics. In one embodiment, gain control algorithms which may be used are presented in U.S. patent application Ser. No. 12/722,730, STABILITY INDICATOR FOR A WIRELESS REPEATER, which is expressly incorporated herein by reference.

Further referring to repeater baseband block 410 in FIG. 4, the repeater baseband block 410 may include a channel estimation block 450 which estimates the feedback channel h[k] and computes an estimate of the feedback signal for the purpose of echo cancellation. In the present embodiment, the echo cancelled output signal y[k] can be used as the pilot signal or the reference signal for channel estimation. The output signal y[k] may be subjected to an adjustable delay block D2 460, to produce delayed output signal y′[k], which may also be provided to the channel estimation block 450. Channel estimation block 450 also receives the input signal x[k]. Channel estimation block 450 computes the feedback channel estimate ĥ[k] using a predefined channel estimation algorithm (Alg), for example, the MMSE algorithm. The feedback channel estimate ĥ[k] as thus computed may be coupled to a feedback signal estimate computation block 462. Feedback signal estimate computation block 462 performs a convolution of the feedback channel estimate ĥ[k] with the receive filter “rxFilter” and with the delayed pilot signal y′[k] to generate the feedback signal estimate \hat{l}[k]. The convolution uses the receive filter so that the feedback signal estimate used for echo cancellation exhibits substantially the same signal characteristics as the receive signal x[k] which is subjected to the same receive filter 443. The feedback signal estimate \hat{l}[k] is coupled to summer 444 to be subtracted from the receive signal to realize echo cancellation of the receive signal.

In the embodiment shown in FIG. 4, a delay element 460 providing an adjustable or variable delay D2 may be introduced in the output signal y[k] and the delayed transmit signal y′[k] is used as the reference or pilot signal for channel estimation and for echo cancellation. Introducing the adjustable delay D2 has the effect of advancing the reference sequence used for channel estimation so that the effective feedback channel is ‘left’ shifted with respect to the channel before any adjustable delay is introduced. In other words, delay D2 has the effect of advancing the channel that is to be estimated. According to some embodiments of the present invention, the tunable delay D2 is adjusted when the repeater is started up and is tuned periodically when the repeater is in operation to account for changes in the delay characteristics of the feedback channel. In one embodiment, the delay D2 may be tuned or adjusted by searching. That is, the delay D2 is adjusted until the desired gain and repeater performance are obtained.

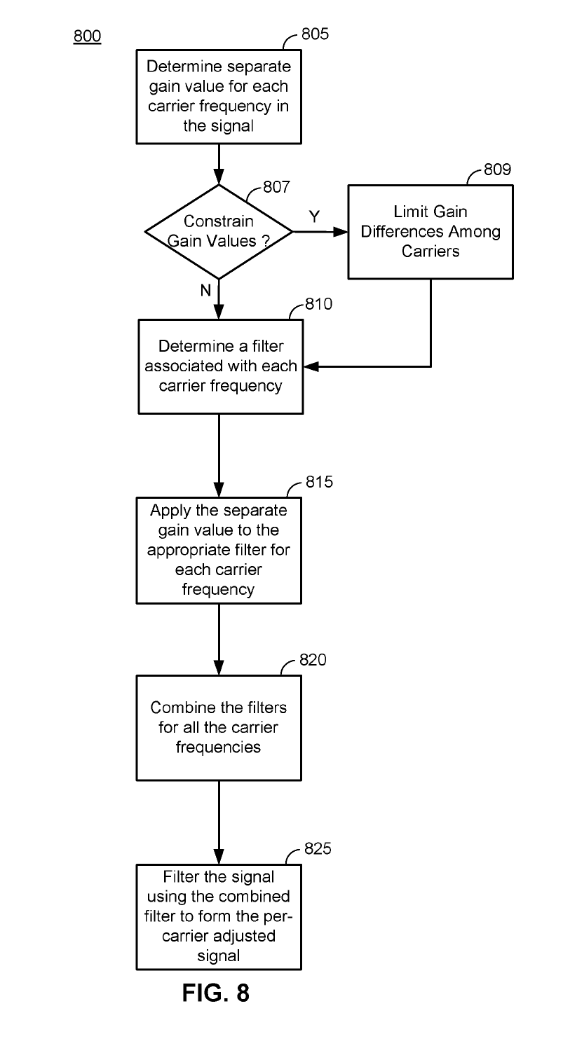

FIG. 5 shows a conceptual block diagram of multi-carrier variable gain stage, wherein signal x″[k] may be fed into a plurality of filters (e.g., a filter bank) 510, wherein each filter may be centered at a different center frequency corresponding to each carrier (fᵢ, i=1, . . . N, where N is the number of carriers). The filter bank 510 separates each carrier from the x″[k] signal, to produce separate component signals x̅″₁[k], . . . , x̅″_{N}[k]. The components may be provided the multi-carrier gain control block 447 to generate separate gain control values Gᵥ₁, . . . , G_{vN} corresponding to each center frequency. The control algorithms used may be conventional algorithms which are traditionally used for wideband gain control. In alternative embodiments, additional logic may be applied so that gain control values among carriers are limited to a predetermined amount. Details of such embodiments will be provided below in the description of FIG. 8.

Further referring to FIG. 5, once each gain control value G_{vC} (where C=1, . . . , N) is determined for each carrier, the corresponding signal component x̅″_{C}[k] may have a gain value applied as a multiplicative factor. As shown in FIG. 5, this operation may be illustrated as each filtered signal being fed into a corresponding amplifier belonging to group of amplifiers 515. Once the gain values have been applied, the signals may be summed together using adder 520 to produce output signal y[k].

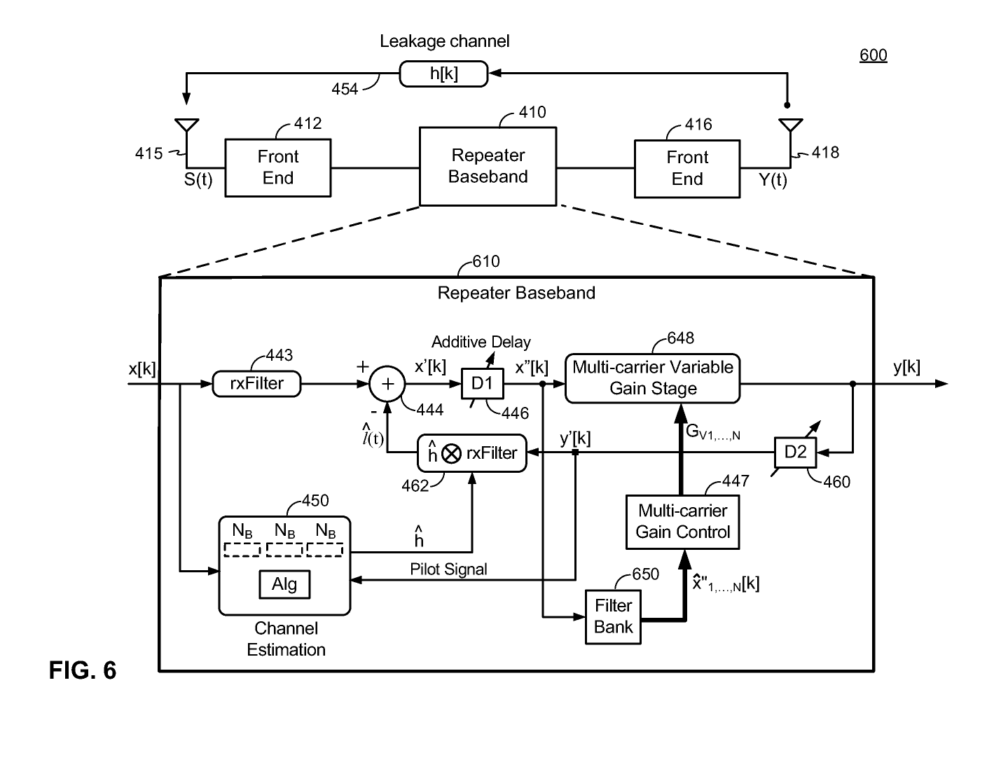

As noted above, the gain value for each of the amplifiers 515 may be set by multi-carrier gain control block 447, and can vary as a function of time to compensate for dynamic changes in the wireless channel. Each separate gain value corresponding to the separate carrier frequencies may be determined independently. The filters in the filter bank may be digital linear filters, for example, finite impulse response (FIR) and/or infinite impulse response (IIR) filters. Some of filter parameters (e.g., number of taps, center frequency, cut-off frequency, bandwidth, etc.) may be fixed according to the requirements of the wireless network. One should appreciate that the conceptual block diagram presented in FIG. 5 is more purpose of explanation, and for computational efficiency, the structure of the multi-carrier variable gain stage 448 may be implemented differently, as will be described in more detail below in reference to FIG. 6.

FIG. 6 is a block diagram of an echo cancellation repeater 600 implementing per carrier gain control using a combined set of filters. This embodiment of the echo cancellation repeater 600 may have some components in common with the echo cancellation repeater 400 as shown in FIG. 4. This is indicated in FIG. 6 where the same reference numbers are used for the common components. Accordingly, for the sake of brevity, the descriptions of common components need not be repeated for the explanation below.

The multi-carrier variable gain stage 648 may provide both filtering and variable gain on a per channel basis, where in this embodiment the combined filter is used to filter the delayed post cancellation signal x″[k] into separate components and apply the variable gain values in the multi-carrier variable gain stage 648. The gain for each carrier may be controlled by a multi-carrier gain control block 447. The output of multi-carrier variable gain stage 648 is an output signal y[k], which is coupled to the front end block 416 where a final gain stage (not pictured) provides an RF gain of G_{f}.

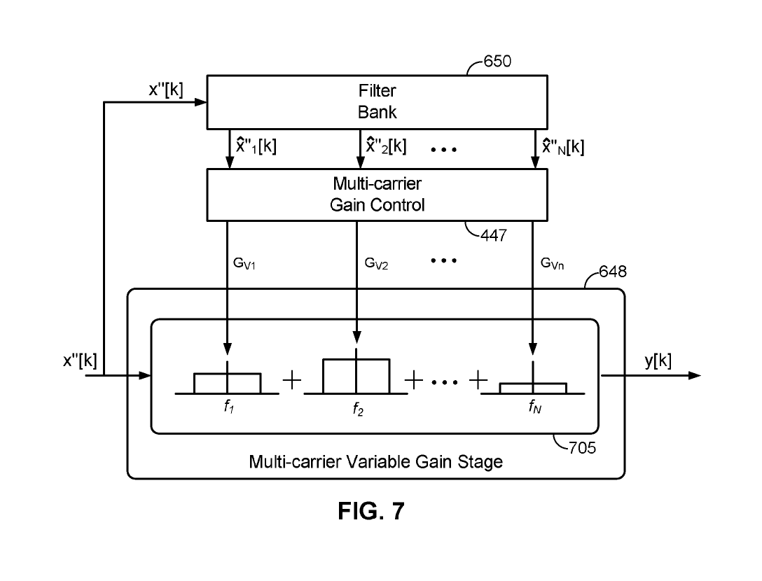

The delayed post cancellation signal x″[k] may be provided to the multi-carrier variable gain stage 648, to properly apply the separate gain values to the signal x″[k]. However, in this embodiment, the signal x″[k] is not explicitly separated into N signal components x̅″₁[k], . . . , x̅″_{N}[k]using N separate filters as in the embodiment described above in FIG. 4. Instead, a single combined filter spectrally isolates the carrier frequencies in the signal x″[k] and appropriately applies the gain values Gᵥ₁, . . . , G_{vN} in a combined operation. The combined filter will be described in more detail below in the description of FIG. 7.

The gain values Gᵥ₁, . . . , G_{vN} may be supplied to the multi-carrier variable gain stage 648 by the multi-carrier gain control block 447. In this embodiment, the N signal components x̅″₁[k], . . . , x̅″_{N}[k] may be supplied by a separate filter bank 650, so that the multi-carrier gain control 447 may determine the appropriate gain values and subsequently provide them to the multi-carrier variable gain stage 648 for their application to the delayed post cancellation signal x″[k]. Because the determination of the gain values Gᵥ₁, . . . , G_{vN} may not require the same quality of spectral separation utilized in the multi-carrier variable gain stage 648, the filter bank 650 may use reduced complexity algorithms to approximate the signal components, denoted by \hat{x}″₁[k], . . . , \hat{x}″_{N}[k].

FIG. 7 is a block diagram showing further implementation details of the multi-carrier variable gain stage 648 according to an embodiment utilizing a combined filter. Because of linearity, each filter in the multi-carrier variable gain stage 648 may be first scaled to the appropriate gain value (Gᵥᵢ) received from the multi-carrier gain control block 447. Once each filter is appropriately scaled, all the filters may be combined and subsequently applied as a single combined filter h_{comb}[k] 705 to the delayed post cancellation signal x″[k]. The combined filter 705 may be represented as follows:

h_{comb}[k]=Σᵢ₌₁^{N}Gᵥᵢ·hᵢ,

where Gᵥᵢ is a gain value associated with carrier frequency fᵢ, hᵢ is the filter associated with carrier frequency fᵢ, and N is number of carriers.

Because the delayed post cancellation signal x″[k] need only undergo a single filtering operation for multi-carrier gain adjustment, N-1 filtering operations (e.g., convolution operations) may be avoided, thus improving the computational efficiency of per channel variable gain adjustment. While these efficiency improvements may be offset somewhat by the additional filtering performed by filter bank 650, the use reduced complexity algorithms used to produce approximate signal components \hat{x}″₁[k], . . . , \hat{x}″_{N} [k] can limit the negative impact of these additional filtering operations. These reduced complexity algorithms may simply be the use of shorter filters, or other known algorithms which may provide an efficient approximate indication of the amount of energy at each carrier frequency fᵢ, so that the gain values Gᵥ₁, . . . , G_{vN} may be determined by the multi-carrier gain control block 447.

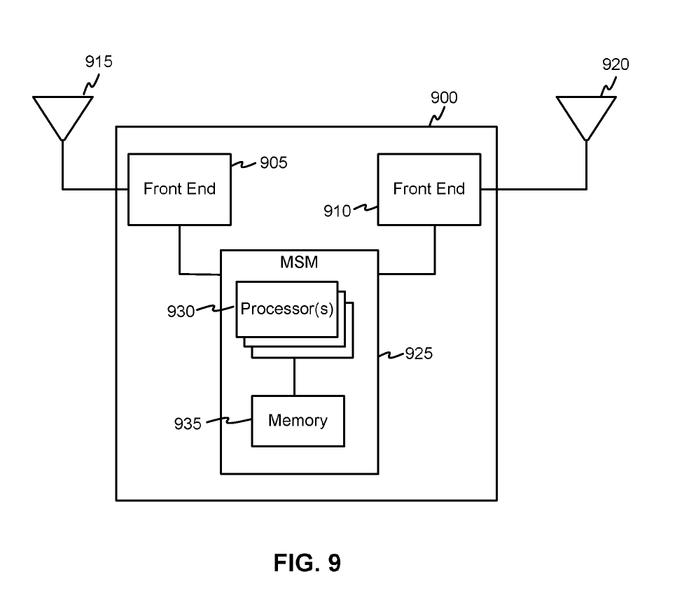

FIG. 8 depicts a flowchart showing an exemplary method 800 for performing per-carrier gain control in a multi-carrier repeater. Method 800 may be performed, for example, by one or more processors within the echo cancellation repeater 400. One embodiment of a processor configuration is shown below in FIG. 9.

Method 800 may start with determining a separate gain value for each carrier frequency in the signal received by the repeater (Block 805). These gain values may be determined using known gain control algorithms, such as, for example, those presented in U.S. patent application Ser. No. 12/722,730, STABILITY INDICATOR FOR A WIRELESS REPEATER expressly incorporated by reference herein.

Once the separate gain values Gᵥ₁, . . . , G_{vN} are determined, a check may be performed to determine whether additional logic should be performed to constrain the gain values among the different carriers (Block 807). If so, control may transfer to Block 809 where such logic may be implemented in either the multi-carrier variable gain stage 448/648, or in the multi-carrier gain control block itself 447. This logic may effectively couple the independent gain control algorithms for each carrier to limit the difference in the adjustment provided among the carriers. Accordingly, the logic would not allow the gain difference between different carriers to exceed a certain amount, which may be set as a predetermined threshold. Similarly, the logic may be configured so a minimum gain which can be set to constrain how low the gain can be driven using gain control.

If the logic described above is applied so that it prevents the gain differences between different carriers exceeding a threshold amount, then the logic can prevent a “lower” carrier (which receives more attenuation) from ultimately being be driven to zero amplitude, which may occur if the gain control algorithms are not constrained. While this may limit the maximum gain a “better” carrier can reach, it only causes a slight degradation (e.g., a few dB), while the “lower” carrier can now enjoy a much higher gain than it otherwise would. It is also possible to simply have a minimum gain level so that the “lower” carrier's gain is never driven below this level.

Upon limiting the gain values among carriers, the method 800 may proceed to Block 810. Alternatively, if it is determined that the gain values need not be constrained in Block 807, Block 809 may be skipped, and the method may proceed directly to Block 810 described below.

A separate filter associated with each carrier frequency may then be determined (Block 810). The specifications for these filters may be predetermined based upon network specifications, and either stored in the repeater during manufacture, and/or provided to the repeater (e.g., over a network) during a configuration and/or update. The separate gain values determined in Block 805 may be applied to the filters determined in Block 810 (Block 815). This may be accomplished by scaling the filter by the separate gain value, for each carrier frequency, wherein the filter and the separate gain value correspond to the same carrier frequency. The scaled filters may then be combined for all the carrier frequencies to produce a combined filter (Block 820). This may be accomplished by adding the scaled filters together. The gain for each carrier in the signal may be adjusted by filtering the signal using the combined filter, thus forming the per-carrier adjusted signal (Block 825).

FIG. 9 is a structural block diagram of an echo cancellation repeater 900 which can be configured to implement per carrier gain control according to an embodiment. Echo cancellation repeater 900 may include first and second front end blocks 905, 910, a donor antenna 915, a server antenna 920, and a Mobile Station Modem (MSM) 925. The first and second front-end blocks 905, 910 may incorporate digital and/or analog processing circuitry for implementing receive and transmit functions of the echo cancellation repeater 900. In one embodiment, the first and second front-end blocks 905, 910 each may incorporate components used in conventional wireless receivers and transmitters. Such components may include variable gain amplifiers, filters, mixers, drivers, modulators, de-modulators, digital-to-analog converters, analog-to-digital converters, etc. Each front end block 905, 910 may support transceiver operations using their respective antennas. For example, first front end block 905 may support the transmission and reception of signals with a base station using donor antenna 915. Front end block 910 may support the transmission and reception of signals with a mobile device using server antenna 920. The first and second front-end blocks 905, 910 may provide analog and/or digital signals which have been down-converted to baseband to the MSM 925. The MSM 925 may perform a signal processing and control functions for repeater communications with the mobile device and base station, including echo cancellation and per carrier gain control, as set forth in the aforementioned embodiments, include the process depicted in the flow chart shown in FIG. 8. The MSM 925 may include one or more processors 930 which can be configured to perform the techniques described herein, and may include general purpose processors, digital signal processors, controllers, etc. The processors may further be functionally coupled to memory 935, which may contain instructions and/or data for utilization by one or more processors 930. Memory 935 may be contained within the MSM 925, reside external to the MSM 925, or both. Additionally, the echo cancellation repeater 900 may further utilize one or more processors (not shown) in addition to those contained in the MSM 925.

Those skilled in the art will understand that information and signals may be represented using any of a variety of different technologies and techniques. For example: data, information, signals, bits, symbols, chips, instructions, and commands may be referenced throughout the above description. These may be represented by voltages, currents, electromagnetic waves, magnetic fields or particles, optical fields or particles, or any combination thereof.

In one or more of the above-described embodiments, the functions and processes described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The term “control logic” used herein applies to software (in which functionality is implemented by instructions stored on a machine-readable medium to be executed using a processor), hardware (in which functionality is implemented using circuitry (such as logic gates), where the circuitry is configured to provide particular output for particular input, and firmware (in which functionality is implemented using re-programmable circuitry), and also applies to combinations of one or more of software, hardware, and firmware.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory, for example the memory of mobile station or a repeater, and executed by any type of processor. A processor may be, for example, a general purpose processor (e.g., a microprocessor), a digital signal processor (DSP), a special purpose processor (e.g., an ASIC), or any combination thereof. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

Also, computer instructions/code may be transmitted via signals over physical transmission media from a transmitter to a receiver. For example, if the software is transmitted from a website, server, or other remote source using a coaxial cable, fiber optic cable, twisted pair, digital subscriber line (DSL), or physical components of wireless technologies such as infrared, radio, and microwave. Combinations of the above should also be included within the scope of physical transmission media.

Moreover, the previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the features shown herein but is to be accorded the widest scope consistent with the principles and novel features disclosed herein.

What is claimed is:

1. A method for adjusting per-carrier gains in a repeater, comprising:
determining a separate gain value for each carrier frequency in a signal;
applying the separate gain value to each carrier frequency in the signal to form a per-carrier gain adjusted signal; and
adjusting the separate gain values based upon a per-carrier stability metric.

2. The method according to claim 1, wherein applying the separate gain value to each carrier frequency occurs within an interference cancelling loop.

3. The method according to claim 1, wherein the applying further comprises:
determining a filter associated with each carrier frequency;
multiplying the filter by the separate gain value associated with each carrier frequency;
combining the filters associated with all carrier frequencies; and
filtering the signal using a combined filter to form the per-carrier gain adjusted signal.

4. The method of claim 1, wherein the applying further comprises:
filtering the signal using separate filters, each filter being centered at each carrier frequency;
applying a separate gain value to each filtered signal; and
summing filtered signals together to form the per-carrier gain adjusted signal.

5. The method according to claim 1, wherein the separate gain values are adjusted to separately maintain stability of each carrier.

6. The method of claim 1, wherein the separate gain value for each carrier frequency is determined independently.

7. The method of claim 1, further comprising:
limiting differences between adjusted gain values associated with different carriers.

8. A wireless repeater having a first antenna to receive an input signal and a second antenna to transmit an amplified signal, the input signal being a sum of a remote signal to be repeated and a feedback signal resulting from a feedback channel between the first antenna and the second antenna, the wireless repeater comprising:
a first front-end block coupled to the first antenna which receives the input signal, the first front-end block further comprising receive and transmit front-end processing circuitry;
a second front-end block coupled to the second antenna which generates the amplified signal, the second front-end block further comprising receive and transmit front-end processing circuitry;
a repeater baseband block coupled between the first front-end block and the second front-end block, the repeater baseband block being configured to receive a processed input signal from the first front-end block, and generate a per-carrier gain adjusted signal to be processed by the second front-end block, the repeater baseband block comprising:
a channel estimation block which receives the processed input signal and estimates the feedback channel to provide a feedback channel estimate;
an echo canceller which receives the feedback channel estimate and generates a feedback signal estimate to substantially cancel the feedback signal from the input signal;
a multi-carrier variable gain stage to amplify an echo cancelled signal on a per carrier basis to generate a per carrier adjusted signal;
a multi-carrier gain control block to adjust a gain of each carrier in the multi-carrier variable gain stage;
a first variable delay element to introduce a first delay either before or after echo cancellation; and
a second variable delay element to introduce a second delay to a per carrier adjusted signal, wherein a delayed per carrier adjusted signal is provided to the channel estimation block as a reference signal to estimate the feedback channel.

9. The wireless repeater according to claim 8, wherein the multi-carrier gain control block determines a separate gain value for each carrier frequency in a signal, and adjusts the separate gain values based upon feedback from the per-carrier gain adjusted signal.

10. The wireless repeater according to claim 9, wherein the multi-carrier variable gain stage
determines a filter associated with each carrier frequency,
multiplies each filter by the separate gain value associated with each carrier frequency,
combines the filters associated with all carrier frequencies, and
filters the signal using a combined filter to form the per-carrier gain adjusted signal.

11. The wireless repeater according to claim 9, wherein the separate gain values are adjusted to separately maintain stability of each carrier.

12. The wireless repeater of claim 8, wherein the separate gain value for each carrier frequency is determined independently.

13. The wireless repeater of claim 8, wherein differences between adjusted gain values associated with different carriers are limited.

14. An apparatus for performing per-carrier gain control in a repeater, comprising:
means for determining a separate gain value for each carrier frequency in a signal;
means for applying the separate gain value to each carrier frequency in the signal to form a per-carrier gain adjusted signal; and
means for adjusting the separate gain values based upon a per-carrier stability metric.

15. The apparatus according to claim 14, wherein applying the separate gain value to each carrier frequency occurs within an interference cancelling loop.

16. The apparatus according to claim 14, wherein the applying further comprises:
means for determining a filter associated with each carrier frequency;
means for multiplying the filter by the separate gain value associated with each carrier frequency;
means for combining the filters associated with all carrier frequencies; and
means for filtering the signal using a combined filter to form the per-carrier gain adjusted signal.

17. The apparatus of claim 14, wherein the applying further comprises:
means for filtering the signal using separate filters, each filter being centered at each carrier frequency;
means for applying a separate gain value to each filtered signal; and
means for summing filtered signals together to form the per-carrier gain adjusted signal.

18. The apparatus according to claim 14, wherein the separate gain values are adjusted to separately maintain stability of each carrier.

19. The apparatus of claim 14, wherein the separate gain value for each carrier frequency is determined independently.

20. The apparatus of claim 14, further comprising:
means for limiting differences between adjusted gain values associated with different carriers.

21. A non-transitory computer readable medium comprising instructions, which, when executed by at least one processor cause the at least one processor to perform per carrier gain control in a repeater, the instructions comprising:
instructions to determine a separate gain value for each carrier frequency in a signal;
instructions to apply the separate gain value to each carrier frequency in the signal to form a per-carrier gain adjusted signal; and
instructions to adjust the separate gain values based upon a per-carrier stability metric.

22. The non-transitory computer readable medium according to claim 21, wherein the instructions to apply the separate gain value to each carrier frequency occurs within an interference cancelling loop.

23. The non-transitory computer readable medium according to claim 21, wherein the applying further comprises:
instructions to determine a filter associated with each carrier frequency;
instructions to multiply the filter by the separate gain value associated with each carrier frequency;
instructions to combine the filters associated with all carrier frequencies; and
instructions to filter the signal using a combined filter to form the per-carrier gain adjusted signal.
